(19) United States
(12) Patent Application Publication
(10) Pub. No.: US 2005/0238869 A9
(43) Pub. Date: Oct. 27, 2005

(54) Nail make-up composition with a mirror effect

(76) Inventors: Roland Ramin, Paris (FR); Roberto Cavazzuti, Paris (FR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/796,987

(22) Filed: Mar. 11, 2004

Related U.S. Application Data
(60) Provisional application No. 60/455,865, filed on Mar. 20, 2003.

(30) Foreign Application Priority Data
Mar. 11, 2003 (FR) 03 03003

(51) Int. Cl. B32B 9/04

(52) U.S. Cl. 428/323; 427/180; 428/328; 428/446

(57) ABSTRACT

Disclosed herein is a composition for making up the nails, comprising, in a physiologically acceptable medium, at least one particle with a metallic glint present in an amount greater than or equal to 2% by weight, relative to the total weight of the composition, and at least one texturizing agent present in an amount less than or equal to 15% by weight, relative to the total weight of the composition. Also disclosed herein is a method of making up nails, comprising, including in a composition, the composition as defined herein for forming a base coat in a multilayer make-up. Further disclosed herein is a multi-compartment kit for making up the nails, wherein the first compartment comprises a first composition comprising, in a first physiologically acceptable medium, at least one particle with a metallic glint present in an amount greater than or equal to 2% by weight, relative to the total weight of the first composition and at least one texturizing agent present in an amount less than or equal to 15% by weight, relative to the total weight of the composition, and wherein the second compartment comprises a second composition, different from the first composition, comprising, in a second physiologically acceptable medium, at least one film-forming agent present in an amount of at least 10% by weight, relative to the total weight of the second composition.

This non provisional application claims the benefit of French Application No. 03 03003 filed on Mar. 11, 2003 and U.S. Provisional Application No. 60/455,865 filed on Mar. 20, 2003.

Disclosed herein is a cosmetic composition for making up the nails using particles with a metallic glint making it possible to obtain a mirror effect. Further disclosed herein is a kit for making up the nails for the purpose of obtaining a make-up with a mirror effect. Additionally, disclosed herein is the method for making up the nails.

The use of metal particles has been described in various types of cosmetic make-up compositions. For example, Patent Application No. EP 1 082 952 discloses make-up compositions, such as for nails, comprising glass particles covered with a metal layer making it possible to obtain a make-up exhibiting a sparkling and wear-resistant metallic appearance. Patent Application No. EP 953 330 also discloses the combination of two different compositions respectively comprising metal particles of goniochromatic pigment type and a pigment of conventional type comprising one of the colors of the first pigment for the production of a make-up with a metallic effect which can vary according to the angle of observation and which exhibits iridescent effects.

More recently, International Patent Application No. WO 02/03913 discloses nail varnish compositions comprising particles in the form of aluminum platelets in an amount ranging from 0.4% to 0.75% by weight, relative to the total weight of the composition and film-forming agents having high molecular weights for the production of a make-up of mirror type, for example, a make-up comprising not only the color of aluminum but also a glossiness and an ability to reflect the separate elements of an object.

The inventors have discovered that it is possible to obtain make-up compositions exhibiting a mirror effect which is improved with respect to those obtained in the prior art by using liquid compositions, of low viscosity, with a reduced content of texturizing agents and with a high content of particles with a metallic glint.

Disclosed herein is a composition, which may be used, for making up the nails, for example, a make-up with a mirror effect, comprising, in a physiologically acceptable medium, at least one particle with a metallic glint present in an amount greater than or equal to 2% by weight, relative to the total weight of the composition, and at least one texturizing agent present in an amount less than or equal to 10% by weight, relative to the total weight of the composition.

Further disclosed herein is a composition, which comprises, in a physiologically acceptable medium, at least one particle with a metallic glint present in an amount greater than or equal to 2% by weight, relative to the total weight of the composition, and at least one texturizing agent present in an amount less than or equal to 15% by weight, relative to the total weight of the composition with the proviso that the composition does not contain silicon dioxide particles coated with a metal or a metal oxide.

Disclosed herein is a composition comprising, in a physiologically acceptable medium, at least one particle with a metallic glint and at least one texturizing agent present in an amount less than or equal to 15% by weight, relative to the total weight of the composition, wherein the composition is capable of forming a film for which the wear resistance, expressed by the loss in weight, measured according to Standard AFNOR NF T30-015, is greater than 5% by weight, for example, greater than 10% by weight, and further, for example, greater than 15% by weight, relative to the total weight of the composition.

Also disclosed herein is a method of making up nails, comprising, including in a composition, the composition as defined above for forming a base coat in a multilayer make-up.

Further disclosed herein is a multi-compartment kit, for example, for use in making up nails, wherein the first compartment comprises a first composition comprising, in a first physiologically acceptable medium, at least one particle with a metallic glint present in an amount greater than or equal to 2% by weight, relative to the total weight of the first composition and at least one texturizing agent present in an amount less than or equal to 15% by weight, relative to the total weight of the composition, and wherein the second compartment comprises a second composition, different from the first composition, comprising, in a second physiologically acceptable medium, at least one film-forming agent present in an amount of at least 10% by weight, relative to the total weight of the second composition.

Disclosed herein is a multi-compartment kit for making up the nails, wherein the first compartment comprises a first composition comprising, in a first physiologically acceptable medium, at least one particle with a metallic glint, wherein the first composition is capable of forming a film for which the wear resistance, expressed as loss in weight, measured according to Standard AFNOR NF T30-015, is greater than 5% by weight, for example, greater than 10% by weight, and further, for example, greater than 15% by weight, relative to the total weight of the first composition, and wherein the second compartment comprises a second composition, different from the first composition, comprising, in a second physiologically acceptable medium, least one film-forming agent present in an amount of at least 10% by weight, relative to the weight of the second composition.

Also disclosed herein is a method for making up the nails comprising applying, to all or part of the surface to be made up, at least one layer of a composition, as defined above.

Disclosed herein is a method for making up the nails comprising applying, to the surface to be made up, at least one layer of each of the compositions of a kit as defined above.

Further disclosed herein is a made-up synthetic support comprising a make-up obtained by the methods disclosed.

Mirror Effect

As used herein, the term “mirror” effect is distinguished from a simple metallic effect by its ability to at least partially reflect the separate elements of an object.

For example, as used herein, the term “make-up with a mirror effect” means a make-up which exhibits an intense specular reflection.

For instance, the films obtained with the compositions, as disclosed herein, can, for example, be advantageous in terms of light reflection. This light reflection is assessed according to the following test:

A layer with a thickness of 150 μm of the test composition (before drying) is deposited on a sheet of glass and then drying is allowed to take place for 24 hours at ambient temperature. The light-reflecting properties of the film obtained are then determined.

The percentage of reflectance is measured using a spectrocolorimeter. For instance, for a perfect mirror (silvered glass method), the value is close to 100%. For a conventional nail varnish formulation with a metallic effect, the maximum value is 45%. For the desired “mirror” effect, the value is at least equal to 50%.

In one embodiment, the compositions, as disclosed herein, are capable of forming a film comprising a percentage of reflectance at least equal to 50%, for example, greater than or equal to 70%.

The compositions disclosed herein are generally fluid, that is to say of low viscosity.

As used herein, the expression “liquid compositions of low viscosity” means compositions generally exhibiting a dynamic viscosity, at 25° C. and at atmospheric pressure ranging from 30 to 250 Pa·s, for example, ranging from 50 to 150 Pa·s, measured using a Brookfield type LV II viscometer.

In one embodiment, formulating the particles with a metallic glint in a composition of low viscosity can be favorable to the physical arrangement of these particles at the time of their application to the make-up support and, for example, favors the achievement of a homogeneous and continuous distribution of the particles, resulting in an improved mirror effect.

Wear Resistance

Furthermore, when the composition, as disclosed herein, is applied to a support, it is possible to obtain, after evaporation of the volatile compounds, a base coat of a film and, for example, a thin film. It is thus possible to obtain a film having a thickness ranging from 0.5 to 30 μm.

The film thus obtained may exhibit a low wear resistance.

The resistance of the film which can be obtained with the compositions disclosed herein are measured according to Standard AFNOR NF T30-015, the principle of which is restated below.

The test composition is applied to a disc in the form of a layer with a thickness of 600 μm (before drying) and then drying is allowed to take place at 30° C. for one hour. The film of the varnish deposited on the disc is subsequently brought into contact for one hour with abrasive discs (Taber abrasion tester), the disc having a rotational speed of one revolution per second. After one hour, the disc is weighed and the loss in weight LW of product, expressed as a percentage of the weight lost relative to the initial weight, is calculated.

Consequently, in this test, the greater the loss in weight, the greater the percentage of weight lost and the lower the wear resistance of the composition.

In one embodiment, the film obtained with the composition, disclosed herein, exhibits a wear resistance, expressed as the loss in weight measured according to Standard AFNOR NF T 30-015, generally greater than 5% by weight, for example, greater than 10% by weight, and further, for example, greater than 15% by weight.

According to an embodiment, the composition, as disclosed, capable of forming a film exhibiting such a wear resistance comprises, in a physiologically acceptable medium, at least one particle with a metallic glint present in an amount greater than or equal to 2% by weight, relative to the total weight of the composition.

This composition can comprise at least one texturizing agent present in an amount less than or equal to 15% by weight, relative to the total weight of the composition. As used herein, at least one texturizing agent includes mixtures of texturizing agents.

The Texturizing Agents

As used herein, the term “texturizing agent” means any organic compound which acts mainly or secondarily on the rheology of the composition disclosed herein.

For example, the agents may be chosen from conventional thickening agents, such as fillers, for example clays, pyrogenic silicas, hydrogenated castor oils, polyamides and cellulose derivatives, and film-forming agents, such as cellulose derivatives in the form of cellulose polymers (for example, nitrocelluloses, cellulose acetate butyrates, cellulose esters and cellulose ethers), and resins, and additional agents which are able to form a film.

In one embodiment, the film-forming agents are mainly intended to facilitate the application of the composition and to provide for the formation of a film while also making it possible to obtain a liquid composition of low viscosity.

In one embodiment, the composition, as disclosed herein, is characterized, for example, by its low proportion of texturizing agents. The texturizing agents may be present in an amount generally less than or equal to 15% by weight, and, for example, less than or equal to 10% by weight, relative to the total weight of the composition.

The texturizing agents may also be present in an amount generally greater than or equal to 2% by weight, and, for example, greater than or equal to 5% by weight, relative to the total weight of the composition.

The texturizing agents used in the compositions, as disclosed herein, are chosen, for example, from film-forming agents, resins, additional agents which are able to form a film, thickening agents and their mixtures.

The Film-Forming Agents

The film-forming agents comprise, for example, film-forming polymers.

As used herein, the term “film-forming polymer” means a polymer capable of forming, by itself alone or in the presence of an additional agent which is able to form a film, an isolable film, for example, a film which is continuous and which adheres to a support, such as to keratinous substances.

In the composition, use may be made of a single film-forming polymer or of a blend of film-forming polymers. This film-forming polymer can be chosen, for example, from the group comprising radical polymers, polycondensates and polymers of natural origin.

The film-forming polymer can be organic or inorganic.

According to one embodiment of the disclosure, the organic film-forming polymer may be chosen from at least one polymer chosen from the group comprising: film-forming polymers which are soluble or dispersible in at least one category of organic solvents, such as, for example, ketones, alcohols, glycols, propylene glycol ethers, short-chain esters, alkanes and their mixtures.

The corresponding polymers can be of any chemical nature. For example, they can result from homopolymerization and copolymerization of unsaturated monomers, from polycondensation, and from the modification of natural polymers, for example, polysaccharides. The weight-average molecular masses (Mw) of these polymers can range from 3,000 to 1,000 000, for example, from 5,000 to 800,000 and further, for example, from 10,000 to 500,000.

The following polymers can, for example, be used among polymers which are soluble or dispersible in organic solvents (non-limiting list):

a) (meth)acrylic acid ester and amide homopolymers and copolymers, such as polymers resulting from the polymerization and copolymerization of methyl, ethyl, propyl, butyl, isobutyl, tert-butyl, pentyl, hexyl, cyclohexyl, 2-ethylhexyl, heptyl, octyl, isobornyl, norbornyl and adamantyl acrylates and methacrylates and the corresponding (meth)acrylamides. These polymers can, for example, comprise from 0 to 20% of a polar comonomer, such as (meth)acrylic acid, (meth)acrylamide, hydroxyethyl (meth)acrylate, 2-hydroxypropyl (meth)acrylate and (meth)acrylonitrile. They can also result from copolymerization with styrenes and substituted styrenes.

b) Vinyl ester and amide homopolymers and copolymers, such as homopolymers and copolymers resulting from the polymerization of vinyl acetate, vinyl propionate and vinyl versatate, optionally with the presence of at least one polar comonomer, such as crotonic acid, allyloxyacetic acid, maleic anhydride (and acid), itaconic anhydride (and acid), vinylacetamide and vinylformamide. Likewise, they can result from the copolymerization of at least one of the monomers mentioned with styrenes and substituted styrenes.

c) Celluloses and cellulose derivatives, such as nitrocelluloses and cellulose esters, for example cellulose acetates, cellulose propionates, cellulose butyrates, cellulose acetate propionates and cellulose acetate butyrates.

d) Polycondensates which are soluble or dispersible in these solvents. They are generally used as main film-forming agents or else as co-film-forming agents for one of the categories of polymers mentioned above (a to c), for example, if they are of low molecular weight (Mw<20 000). They can be chosen from the following polymers and copolymers: polyurethanes, acrylic polyurethanes, polyureas, polyurea polyurethanes, polyester polyurethanes, polyether polyurethanes, polyesters, polyesteramides, polyesters with a fatty chain, epoxys and arylsulphonamide condensates, such as tosylamide/formaldehyde condensates.

Non-limiting mention may be made, among these polycondensates, for example, if they are used as film-forming agent or co-film-forming agent for at least one nitrocellulose and for a cellulose ester (category c), of:
polyesters, for example, polyesters with a fatty chain, such as copolymers with the CTFA name: “phthalic anhydride/glycerol/glycidyl decanoate copolymer” and “adipic acid/neopentyl glycol/trimellitic anhydride copolymer”,
alkyds,
tosylamide/formaldehyde condensates,
polyurethanes and polyurea-urethanes,
acrylic resins, and
silicone resins (non volatile and partially volatile).

According to one embodiment, the at least one, film-forming polymer can be chosen from aqueous dispersions of polymer particles or film-forming latexes and, for example, the composition, as disclosed herein, comprises at least one aqueous phase.

The aqueous dispersion comprising at least one film-forming polymer can be prepared by a person of ordinary skill in the art on the basis of his or her general knowledge, for example, by emulsion polymerization or by dispersing the polymer formed beforehand.

Among the film-forming polymers which can be used in the composition, as disclosed herein, non-limiting mention may be made of: synthetic polymers, polycondensate type and radical type polymers, polymers of natural origin, and their blends.

Use may, for example, be made, but in the latex form, of the polymers (homo- and copolymers) which are mentioned above as polymers which are soluble or dispersible in an organic solvent medium and, for example, of the polymers of categories a, b and c.

Among polycondensates, non-limiting mention may, for example, be made of anionic, cationic, non-ionic and amphoteric polyurethanes, polyurethane-acrylics, polyurethane-polyvinylpyrrolidones, polyester-polyurethanes, polyether-polyurethanes, polyureas, polyurea-polyurethanes and of their blends.

Mention may also be made of polyesters, polyesteramides, polyesters with a fatty chain, polyamides and epoxy ester resins.

The polyesters may be obtained, in a known way, by polycondensation of aliphatic and aromatic diacids with aliphatic and aromatic diols and with polyols. Use may be made, as aliphatic diacids, of succinic acid, glutaric acid, adipic acid, pimelic acid, suberic acid and sebacic acid. Use may be made, as aromatic diacids, of terephthalic acid and isophthalic acid, and of derivatives, such as phthalic anhydride. Use may be made, as aliphatic diols, of ethylene glycol, propylene glycol, diethylene glycol, neopentyl glycol, cyclohexanedimethanol and 4,4′-(1-methylpropylidene)bisphenol. Use may be made, as polyols, of glycerol, pentaerythritol, sorbitol and trimethylolpropane.

Radical type polymers can for example, be chosen from acrylic and vinyl polymers and copolymers. For example, anionic radical polymers may be used. Mention may be made of monomers carrying an anionic group which can be used during the radical polymerization, of acrylic acid, methacrylic acid, crotonic acid, maleic anhydride and 2-acrylamido-2-methylpropanesulphonic acid.

The acrylic polymers can result from the copolymerization of monomers chosen from esters and amides of acrylic acid or of methacrylic acid. Non-limiting mention of monomers of the ester type include, for example, methyl methacrylate, ethyl methacrylate, butyl methacrylate, isobutyl methacrylate, 2-ethylhexyl methacrylate and lauryl methacrylate. As examples of monomers of the amide type, mention may be made of N-(t-butyl)acrylamide and N-(t-octyl)acrylamide.

The vinyl polymers can result from the homopolymerization or from the copolymerization of monomers chosen from vinyl esters, styrenes and butadienes. As examples of vinyl esters, non-limiting mention may be made of vinyl acetate, vinyl neodecanoate, vinyl pivalate, vinyl benzoate and vinyl t-butylbenzoate.

Use may also be made of acrylic/silicone copolymers and nitrocellulose/acrylic copolymers.

Mention may also be made of the polymers resulting from the radical polymerization of at least one radical monomer inside and/or partially on the surface of pre-existing particles of at least one polymer chosen from the group comprising of polyurethanes, polyureas, polyesters, polyesteramides and alkyds. These polymers are generally referred to as hybrid polymers.

The dispersion can also comprise associative polymers of polyurethane type and natural gums, such as xanthan gum.

Among polymers in aqueous dispersion, Non-limiting mention may be made of the dispersions of acrylic polymers sold under the names Neocryl XK-90®, Neocryl A-1070®, Neocryl A-1090®, Neocryl BT-62®, Neocryl A-1079® and Neocryl A-523® by Zeneca or Dow Latex 432® by Dow Chemical. Use may also be made of aqueous polyurethane dispersions and, for example, the polyester-polyurethanes sold under the names “Avalure UR-405®”, “Avalure UR-410®”, “Avalure UR-425®” and “Sancure 2060®” by Goodrich and the polyether-polyurethanes sold under the names “Sancure 878®” by Goodrich and “Neorez R-970®” by Avecia.

According to another embodiment, the film-forming polymer can be chosen from water-soluble and water-dispersible polymers and, for example, the composition, as disclosed herein, can comprise at least one aqueous phase.

Mention may be made, as water-dispersible polymers, of water-dispersible polycondensates with sulphonate functional groups, such as copolyesters composed of units derived from isophthalic acids, sodium salt of sulphoisophthalic acids, diethylene glycol, and 1,4-cyclohexanedimethanol, these copolyesters can be present, for example, in proportions of 89/11/78/22 and, for example, of 82/18/54/46. These polycondensates are sold under the names of “AQ 38/” and “AQ 55/” respectively by Eastman Kodak.

Among water-soluble polymers, non-limiting mention may be made of water-soluble copolymers with carboxylic acid functional groups (such as synthetic polymers) which are preferably chosen from:
a) polyoxyethylenated crotonic acid/vinyl acetate copolymers,
b) N-octylacrylamide/methyl methacrylate/hydroxypropyl methacrylate/-acrylic acid/tert-butylaminoethyl methacrylate copolymers,
c) alternating methyl vinyl ether/maleic anhydride copolymers monoesterified by butanol,
d) acrylic acid/ethyl acrylate/N-(tert-butyl)acrylamide terpolymers, and
e) vinyl acetate/crotonic acid copolymers, vinyl acetate/crotonic acid/vinyl neodecanoate terpolymers, vinyl 4-(tert-butyl)benzoate and their blends.

The choice of the types of film-forming polymers used should depend on the type of physiologically acceptable medium chosen for the composition.

In one embodiment, in the composition, the content of film-forming polymers can be present in an amount ranging from 0.1% to 15% by weight, for example, from 5% to 10% by weight, and further, for example, less than or equal to 7% by weight, relative to the total weight of the composition.

Additional Agent Which is Able to Form a Film

The additional agent which is able to form a film can be chosen from any compound known to a person of ordinary skill in the art as being capable of fulfilling the desired function and can be chosen, for example, from plasticizers and coalescents for the film-forming polymer.

Mention may, for example, be made, alone or as a mixture, of conventional plasticizers and coalescents, such as:
glycols and their derivatives, such as diethylene glycol ethyl ether, diethylene glycol methyl ether, diethylene glycol butyl ether, diethylene glycol hexyl ether, ethylene glycol ethyl ether, ethylene glycol butyl ether and ethylene glycol hexyl ether,
glycol esters,
propylene glycol derivatives and, for example, propylene glycol phenyl ether, propylene glycol diacetate, dipropylene glycol butyl ether, tripropylene glycol butyl ether, propylene glycol methyl ether, dipropylene glycol ethyl ether, tripropylene glycol methyl ether, diethylene glycol methyl ether and propylene glycol butyl ether,
esters of acids, for example, carboxylic acids, such as citrates, for instance, triethyl citrate, tributyl citrate, triethyl acetylcitrate, tributyl acetylcitrate or tri(2-ethylhexyl) acetylcitrate; phthalates, such as diethyl phthalate, dibutyl phthalate, dioctyl phthalate, dipentyl phthalate and dimethoxyethyl phthalate; phosphates, such as tricresyl phosphate, tributyl phosphate, triphenyl phosphate and tributoxyethyl phosphate; tartrates, such as dibutyl tartrate; adipates; carbonates; sebacates; benzyl benzoate; butyl acetylricinoleate; glyceryl acetylricinoleate; butyl glycolate; camphor; glyceryl triacetate; and N-ethyl-o,p-toluenesulphonamide,
oxyethylenated derivatives, such as oxyethylenated oils, for example, vegetable oils, such as castor oil and silicone oils, and
their mixtures.

In one embodiment, the type and the amount of plasticizer and coalescent can be chosen by a person of ordinary skill in the art on the basis of his, or her, general knowledge, so as to obtain a composition comprising cosmetically acceptable properties, with the proviso, that the total amount of texturizing agent does not exceed that indicated above and that the composition retains its characteristic of fluidity and/or of ability to form a film having a low wear resistance.

For example, the content of plasticizer and/or coalescent can range from 0.01% to 10% by weight, and, for example, from 1% to 3% by weight, relative to the total weight of the composition.

Thickening Agent

The thickening agent can, for example, be a thickener for a non-aqueous phase and can be chosen from: hydrophobic silicas, such as those disclosed in document EP-A-898 960 and, for example, sold under the references “Aerosil R812®” by Degussa; “Cab-O-Sil TS-530®”, “Cab-O-Sil TS-610®” and “Cab-O-Sil TS-720®” by Cabot and “Aerosil R972®” and “Aerosil R974®” by Degussa; clays, such as montmorillonite, and modified clays, such as bentones, for example stearalkonium hectorite and stearalkonium bentonite, and polysaccharide alkyl ethers (for example, wherein the alkyl group comprises from 1 to 24 carbon atoms, such as from 1 to 10, further, for example, from 1 to 6 carbon atoms and, for example, from 1 to 3 carbon atoms), such as those disclosed in the document EP-A-898 958.

The thickening agent can also be chosen from thickeners for an aqueous phase, such as an aqueous gelling polymers and clays.

The total proportion of thickening agents in the compositions, as disclosed herein, is generally less than or equal to 5% by weight, for example less than or equal to 2% by weight, and further, for example, less than or equal to 1% by weight, relative to the total weight of the composition.

The Particles with a Metallic Glint

As used herein, the term “particles with a metallic glint” means particles where the nature, size, structure and surface condition of the particles allow them to reflect the incident light, for example, in a non-iridescent way.

The particles with a metallic glint which can be used in the compositions, as disclosed herein, can be chosen, for example, from:
particles chosen from at least one metal and at least one metal derivative,
particles comprising at least one substrate chosen from monomaterial, multimaterial, organic, and inorganic substrates at least partially covered with at least one layer with a metallic glint comprising at least one metal and at least one metal derivative, and
mixtures of the particles.

Among the metals which may be present in the particles, non-limiting mention may be made of, for example, Ag, Au, Cu, Al, Ni, Sn, Mg, Cr, Mo, Ti, Zr, Pt, Va, Rb, W, Zn, Ge, Te, Se and their mixtures and alloys. For example, Ag, Au, Cu, Al, Zn, Ni, Mo, Cr and their mixtures and alloys (for example, bronzes and brasses) can be used.

As used herein, the term “metal derivatives” means compounds derived from metals, such as oxides, fluorides, chlorides and sulphides.

Non-limiting examples of the metal derivatives which can be present in the particles include: metal oxides, such as titanium oxides, for example, TiO₂, iron oxides, for example, Fe₂O₃, tin oxides and chromium oxides, and the following compounds: MgF₂, TiCl₄, CrF₃, ZnS, ZnSe, Al₂O₃, MgO, SeO₃, ZrO₂, MoS₂ and their mixtures or alloys.

In one embodiment, the at least one particle with a metallic glint comprise at least one entity chosen from at least one metal as defined above, at least one metal derivative as defined above and their mixtures.

These particles can be at least partially covered by a layer of another material, for example of transparent material, such as rosin, silica, stearates, polysiloxanes, polyester resins, epoxide resins, polyurethane resins and acrylic resins.

Mention may be made, for example, of particles chosen from aluminum particles, such as those sold under the names Starbrite 1200 EAC® by Siberline and Metalure® by Eckart.

Non-limiting mention may also be made of metal powders formed from copper and from alloy mixtures, such as the references 2844 sold by Radium Bronze, metal pigments, such as aluminum and bronze, for example those sold under the names Rotosafe 700 from Eckart, aluminum particles coated with silica sold under the name Visionaire Bright Silver from Eckart, and particles of metal alloy, such as powders formed from bronze (for example, copper and zinc alloy), coated with silica, which are sold under the name Visionaire Bright Natural Gold from Eckart.

In one embodiment, the at least one particle with a metallic glint is chosen from particles which comprise a substrate and which therefore can exhibit a multilayer structure, for example a two-layer structure. This substrate can be chosen from organic, inorganic, natural, synthetic, monomaterial, multimaterial, solid, and hollow substrates. When the substrate is synthetic, it can be produced with a shape favoring the formation of a reflective surface after coating, for example, after the deposition of a layer of materials with a metallic glint. The substrate can, for example, exhibit a flat surface and the layer of materials with a metallic glint of substantially uniform thickness.

The substrate may, for example, be chosen from metals and metal derivatives as mentioned above and also be chosen from (non-limiting list) glasses, ceramics, aluminas, silicas, silicates, such as aluminosilicates and borosilicates, synthetic mica, such as fluorophlogopite, and their mixtures.

The layer with a metallic glint can entirely or partially coat the substrate and this layer can be at least partially covered by a layer of another material, for example a transparent material, for example, as mentioned above. According to one embodiment, the layer with a metallic glint entirely coats the substrate, directly or indirectly, that is to say with interposition of at least one metal or non-metal intermediate layer.

The metals or metal derivatives which can be used in the layer with a metallic glint are as defined above.

Glass particles covered with a metal layer are disclosed, for example, in the documents JP-A-09188830, JP-A-10158450, JP-A-10158541, JP-A-07258460 and JP-A-05017710.

For example, the particles comprising a glass substrate, may be chosen from those coated respectively with silver, with gold or with titanium, in the form of platelets, sold by Nippon Sheet Glass under the names Microglass Metashine, and those coated either with brown iron oxide, on the one hand, or with titanium oxide, with tin oxide or with one of their mixtures, on the other hand, such as those sold under the name Reflecks® by Engelhard or those sold under the reference Metashine MC 2080GP by Nippon Sheet Glass.

In one embodiment, the glass particles covered with metals can be coated with silica, such as those sold under the name Metashine series PSS1 or GPS1 by Nippon Sheet Glass.

Among the particles with a metallic glint comprising a substrate which can be used in the compositions, as disclosed herein, mention may also be made, of particles with interferential multilayers.

Examples of a multilayer structure comprising a metal layer which can be used in compositions produced, as disclosed herein, include, for example, the following structures: Al/SiO₂/Al/SiO₂/Al, particles comprising this structure are sold by Dupont de Nemours; Cr/MgF₂/Al/MgF₂/Cr, particles comprising this structure are sold under the name of Chromaflair by Flex; MoS₂/SiO₂/Al/SiO₂/MoS₂; Fe₂O₃/SiO₂/Al/SiO₂/Fe₂O₃ and Fe₂O₃/SiO₂/Fe₂O₃/SiO₂/Fe₂O₃, particles comprising this structure are sold under the name of Sicopearl by BASF; or MoS₂/SiO₂/mica-oxide/SiO₂/MoS₂; Fe₂O₃/SiO₂/mica-oxide/SiO₂/Fe₂O₃; TiO₂/SiO₂/TiO₂ and TiO₂/Al₂O₃/TiO₂, particles comprising these structures are sold under the name Xirona by Merck (Darmstadt).

According to one embodiment, the composition may be free of particles of silicone dioxide coated with metal oxides, and, for example, with metal and metal derivatives.

The at least one particle with a metallic glint used in the compositions, as disclosed herein, can exhibit varied shapes. For example, they can be flat. As used herein, the term “flat particles” means particles with a surface which exhibits substantially no bumps and no unevenness and which exhibit only a slight curvature, for instance, even no curvature.

These particles can, for example, exist in the form of platelets. As used herein, the term “platelets” means particles wherein the ratio of the greatest dimension to the smallest dimension, known as the shape factor, is greater than or equal to 5.

As used herein, the term “dimensions” means the dimensions given by the random particle size distribution of half the population, referred to as D50.

The at least one particle with a metallic glint may, for example, comprise a shape factor of greater than or equal to 8, for example, of greater than or equal to 10, and further, for example, of greater than or equal to 15.

The at least one particle with a metallic glint used in the compositions, as disclosed herein, may, for example, comprise, according to their greatest dimension, a mean size of less than or equal to 25 μm, for example, of less than or equal to 10 μm, and further, for example, of approximately 6 μm.

As used herein, the term “mean size” means the dimension given by the random particle size distribution of half the population, referred to as D50.

The particles can generally have a thickness of less than or equal to 1 μm, for example, of less than or equal to 0.7 μm, and further, for example, of less than or equal to 0.5 μm.

The total proportion of particles with a metallic glint may generally be greater than or equal to 2% by weight, for example, greater than or equal to 3% by weight, for example, greater than or equal to 5% by weight, and further, for example, greater than or equal to 7% by weight, relative to the total weight of the composition. The total proportion of particles with a metallic glint is, for example, less than or equal to 70% by weight, such as less than or equal to 20% by weight, and further, for example, less than or equal to 10% by weight, relative to the total weight of the composition.

Physiologically Acceptable Medium

In one embodiment, the composition, as disclosed herein further comprises a physiologically acceptable medium. As used herein, this term means a non-toxic medium capable, for example, of being applied to the superficial body growths of human beings.

This medium can be chosen from organic solvents, aqueous solvents and mixed solvent types.

The physiologically acceptable medium of the composition generally comprises at least one volatile solvent. The volatile solvent can be chosen, for example, from volatile organic solvents, water and their mixtures.

Organic Solvents

The composition, as disclosed herein, can comprise at least one organic solvent medium comprising an organic phase comprising at least one organic solvent which is volatile at ambient temperature.

Among organic solvents which are volatile or non-volatile at ambient temperature, non-limiting mention may be made of:
ketones which are liquid at ambient temperature, such as methyl ethyl ketone, methyl isobutyl ketone, diisobutyl ketone, isophorone, cyclohexanone and acetone;
alcohols which are liquid at ambient temperature, such as ethanol, isopropanol, butanol, diacetone alcohol, 2-butoxyethanol and cyclohexanol;
glycols which are liquid at ambient temperature, such as ethylene glycol, propylene glycol, pentylene glycol and glycerol;
propylene glycol ethers which are liquid at ambient temperature, such as propylene glycol monomethyl ether, propylene glycol monomethyl ether acetate and dipropylene glycol mono(n-butyl) ether;
short-chain esters (comprising from 3 to 8 carbon atoms), such as methyl acetate, ethyl acetate, propyl acetate, n-butyl acetate, and isopentyl acetate and aryl acetate;
alkanes which are liquid at ambient temperature, such as decane, heptane, octane, dodecane, cyclohexane and isododecane;
aldehydes which are liquid at ambient temperature, such as benzaldehyde and acetaldehyde, and their mixtures.

The solvent may be chosen, for example, from short-chain esters (comprising from 3 to 8 carbon atoms), alcohols which are liquid at ambient temperature, and their mixtures.

The composition, as disclosed herein, can also comprise at least one silicone oil, generally in a small amount, that is to say which may be present in an amount less than 10% by weight of the solvent phase. The at least one silicone oil may, for example, be chosen from volatile and non-volatile oils, such as dimethicones, phenyl dimethicones, alkyl dimethicones, dimethicone copolyols and cyclomethicones.

In one embodiment, when the physiologically acceptable medium comprises a significant amount of organic phase, the latter can be present in an amount ranging from 30% to 97% by weight and, for example, ranging from 50% to 95% by weight, relative to the total weight of the composition.

Aqueous Phase

The composition, as disclosed herein, may also comprise at least one aqueous medium, comprising an aqueous phase, which can form the continuous phase of the composition.

The aqueous phase may comprise water; it can also comprise a mixture of water and of at least one water-miscible organic solvent (wherein miscibility in water may be greater than 50% by weight at 25° C.), such as lower monoalcohols comprising from 1 to 5 carbon atoms, for example, ethanol and isopropanol, glycols comprising from 2 to 8 carbon atoms, such as propylene glycol, ethylene glycol, 1,3-butylene glycol and dipropylene glycol, C₃-C₄ ketones and C₂-C₄ aldehydes.

The aqueous phase (water and optionally water-miscible organic solvents) may be present in an amount ranging from 30% to 97% by weight, and, for example, ranging from 50% to 80% by weight, relative to the total weight of the composition.

Additives

The compositions disclosed herein can further comprise at least one additive, for example, an additional coloring material chosen from natural and synthetic pearlescent agents, non-metallic pigments, non-metallic particles (comprising as support, for example: glass, polyacrylate, polyurethane and poly(butylene terephthalate)), natural and synthetic fibers and water-soluble and fat-soluble dyes.

The composition for making up the nails, as disclosed herein, can, for example, be a nail varnish composition. This composition can be applied to natural or synthetic nails, such as false nails.

Further disclosed herein is the use of a composition as defined above to form a base coat in a multilayer make-up.

Make-Up Kit

Also disclosed herein is a multi-compartment device or kit, for example, for making up nails, comprising at least one compartment, wherein the first compartment comprises a first composition comprising, in a first physiologically acceptable medium, at least one particle with a metallic glint present in an amount greater than or equal to 2% by weight and, for example, greater than 3% by weight, relative to the total weight of the first composition, and wherein the second compartment comprises a second composition, different from the first composition, comprising, in a second physiologically acceptable medium, at least 10% by weight, relative to the total weight of the second composition, of at least one film-forming agent.

Further disclosed herein is a multi-compartment device or kit, for example, for making up nails, comprising at least one compartment, wherein the first compartment comprises a first composition comprising, in a first physiologically acceptable medium, at least one particle with a metallic glint, wherein the first composition is capable of forming a film for which the wear resistance, measured according to Standard AFNOR NF T30-015, is greater than 5% by weight, for example, greater than 10% by weight and further, for example, greater than 15% by weight, relative to the weight of the first composition and wherein the second compartment comprises a second composition, different from the first composition, comprising, in a physiologically acceptable medium, at least 10% by weight, relative to the weight of the second composition, of at least one film-forming agent.

In one embodiment, the first composition can be a composition for making up nails as defined above.

The second composition of the kit may, according to one embodiment, comprise at least one film-forming agent present in an amount of at least 15% by weight, relative to the total weight of the second composition.

The film forming agents are generally conventional film-forming agents and, for example, film-forming polymers which may be soluble or dispersible in organic solvents and film-forming latexes, for example, as described above. The choice of these film-forming agents is also made according to the nature of the physiologically acceptable medium of the second compositions. The second compositions of the kit, as disclosed herein, can also comprise at least one additional agent which is able to form a film, such as those described above.

The plasticizer and/or coalescent may be present in the composition in an amount ranging from 0.01% to 15% by weight and, for example, from 2% to 7% by weight, relative to the total weight of the composition.

The second composition can further comprise at least one conventional thickening agent chosen, for example, from those described above.

The proportion of thickening agents present in the second composition can range from 0.01 to 3% by weight, relative to the total weight of the composition.

The physiologically acceptable medium of the first composition and of the second composition, as disclosed herein, may be chosen from a non-toxic medium capable, for example, of being applied to the superficial body growths of human beings. This medium can be chosen from organic, aqueous and mixed type mediums. It generally comprises at least one volatile solvent which can be chosen, for example, from volatile organic solvents, water and their mixtures.

Non-limiting mention may be made of the solvents described above which can, for example, be used in the second composition.

However, a person of ordinary skill in the art will take care to choose the second physiologically acceptable medium so that the application of the second composition to the film capable of being generated by the application of the first composition and then drying it does not affect the film and, for example, does not dissolve the film and does not dilute the film.

The aqueous phase (such as water and optionally the water-miscible organic solvent), the organic phase and the sum of these two phases may be present in an amount ranging from 1% to 90% by weight, for example, ranging from 5% to 60% by weight and further, for example, ranging from 15% to 40% by weight, relative to the total weight of the second composition.

The second composition should not obstruct the expression of the desired mirror effect.

Generally, the second composition of the kit, as disclosed herein, is translucent, semi-transparent or transparent.

In one embodiment, the second composition can also be described as bulk translucent or transparent. This property of bulk transparency or translucency means that a layer with a thickness arbitrarily set at 1 cm allows a portion of the visible light to pass, either while scattering it (bulk translucent compositions) or without scattering it (bulk transparent compositions). For example, the optical density is measured by using quartz cells with a thickness of 10 mm. The value of the optical density must be less than 1.

The second composition can further comprise a coloring material which can be chosen from dyes which are soluble in the second physiologically acceptable medium and optionally pulverulent compounds.

The dyes are chosen, for example, from Sudan red, DC Red 17, DC Green 6, β-carotene, soybean oil, Sudan brown, DC Yellow 11, DC Violet 2, DC Orange 5 and quinoline yellow.

The pulverulent compounds can be chosen from pigments and pearlescent agents, which may be natural or synthetic, and glitter and fibers generally used in cosmetic compositions for making up the nails, such as nail varnishes.

The pigments may be chosen from white, colored, inorganic, and organic pigments. For example, among these pigments non-limiting mention may be made of carbon black, pigments of D & C type, lakes based on cochineal carmine and on barium, strontium, calcium and aluminum, and guanine.

As used herein, the term “pearlescent agents” means iridescent particles, for example, particles produced by certain molluscs in their shells or synthesized.

The glitter and the fibers can be chosen from those made of materials chosen from acrylic resin, polyester, poly(ethylene terephthalate) and polyurethane type.

The coloring material may be present in an amount ranging from 0.01% to 10% by weight, relative to the total weight of the composition.

The proportions are given generally but it is understood that a person of ordinary skill in the art will take care that the nature of these compounds and their concentrations do not substantially affect the mirror effect of the first composition.

The second composition of the kit, as disclosed herein, can further comprise at least one additive chosen from spreading agents, wetting agents, dispersing agents, antifoaming agents, preservatives, UV screening agents, active principles, surfactants, fragrances, neutralizing agents, stabilizing agents and antioxidants.

For example, the second composition is intended to be used as a top coat for the make-up and, for example, as a nail varnish top coat. However, it can also be employed as a base coat. For example, at least one layer of the first composition can be superimposed on it.

In one embodiment, the ingredients of the second composition and their concentrations can be chosen by a person of ordinary skill in the art, with the proviso of the conditions mentioned above in order to obtain the desired mirror effect. For example, these ingredients will be chosen in order for the second composition to form, after application, a glossy and adherent film which exhibits a satisfactory wear resistance.

The compositions of the present invention can be obtained according to preparation methods conventionally used in cosmetics.

Further disclosed herein is a method for making up the nails comprising applying, to all or part of the surface to be made up, of at least one layer of the first composition of the kit defined above or of a cosmetic composition for making up the nails as defined above.

Also disclosed herein is a method for making up the nails comprising applying, to all or part of the surface to be made up, of at least one layer of each of the two compositions of the kit as defined above.

Generally, at least one layer of the first composition can be applied, on which at least one layer of the second composition can subsequently be superimposed. However, it is also possible to reverse the order of superimposition of these compositions, that is to say to first use the deposition of at least one layer of the second composition as a base coat and the consecutive application of at least one layer of the first composition. However, in one embodiment, it is desirable to carry out a further application of at least one layer of the second composition at the surface of the metal layer. This method of application, involving superimposition of several layers of two compositions, can, for example, be advantageous for improving the smoothing of the metal layer and, for example, the properties of the make-up thus obtained in terms of gloss and/or of hold.

The first composition can be applied uniformly or non-uniformly, such as discontinuously, for example, in the form chosen from symmetrical and asymmetrical geometrical patterns (for example, in the form chosen from dots, squares, rings and stars), distributed in a random and ordered ways with clear and blurred outlines on the surface to be made up of the nail.

In one embodiment, after application of the first composition, it is preferable to leave a sufficient time until a solid film is obtained before applying the second composition.

The second composition is generally applied uniformly over the surface to be made up, even if it is, however, possible to apply it only to the film formed by the first composition.

In the method of the invention, natural and synthetic nails provide the support for making up the nail.

Even further disclosed herein is a made-up support comprising a make-up capable of being obtained by the method defined above. The support is, for example, an accessory for making up the nail, such as a false nail.

Other than in the operating examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements. The following examples are intended to illustrate the invention without limiting the scope as a result. The percentages are given on a weight basis.

The non-limiting examples given below are given by way of illustration.

### EXAMPLE 1

### Implementational Example of a Nail Varnish

The following compositions were prepared according to conventional methods:

| | | |
|---|---|---|
| a) Composition for forming a base coat with a | | |
| mirror effect | | |
| Dispersion of aluminum particles sold under the | 40 | g |
| name of Starbrite 1200 EAC ® by Siberline* | | |
| Cellulose acetate butyrate (film-forming agent) | 4 | g |
| Bentone (rheological agent) | 0.5 | g |
| Ethyl acetate (solvent) | q.s. for 100 | g |
| b) Top coat | | |
| Cellulose acetate butyrate (film-forming agent) | 15 | g |
| Ethyl tosylamide (plasticizer) | 3 | g |
| Dimethicone | 0.2 | g |
| Ethyl alcohol | q.s. for 100 | g |

*Starbrite 1200 EAC ® is a product comprising 20% by weight of dry matter in 80% of ethyl acetate.

The composition for forming the base coat with a mirror effect was applied continuously, in the form of a monolayer, to nails devoid of make-up. After drying, a make-up film exhibiting a marked mirror effect was obtained.

The second composition was then applied to the film formed by the base coat. After drying, a make-up with a marked mirror effect which was very glossy and which exhibited a satisfactory wear resistance was obtained.

1. A composition comprising, in a physiologically acceptable medium, at least one particle with a metallic glint present in an amount greater than or equal to 2% by weight, relative to the total weight of the composition, and at least one texturizing agent present in an amount less than or equal to 10% by weight, relative to the total weight of the composition.

2. The composition according to claim 1, wherein the at least one texturizing agent is a mixture of texturizing agents.

3. The composition according to claim 1, wherein the at least one particle with a metallic glint is present in an amount greater than or equal to 5% by weight, relative to the total weight of the composition.

4. The composition according to claim 2, wherein the at least one particle with a metallic glint is present in an amount greater than or equal to 7% by weight, relative to the total weight of the composition.

5. The composition according to claim 3, wherein the at least one particle with a metallic glint is present in an amount ranging from 2% to 20% by weight, relative to the total weight of the composition.

6. The composition according to claim 1, wherein the at least one particle with a metallic glint is chosen from:
metals and metal derivatives and
substrates at least partially covered with at least one layer of a metallic glint chosen from metals and metal derivatives.

7. The composition according to claim 6, wherein the at least one particle with a metallic glint is a mixture of said metals, said metal derivatives, and said substrates.

8. The composition according to claim 6, wherein the at least one metal is chosen from Ag, Au, Cu, Al, Zn, Ni, Mo, and Cr.

9. The composition according to claim 6, wherein the at least one metal derivative is chosen titanium oxides, iron oxides, tin oxides, chromium oxides, MgF₂, TiCl₄, CrF₃, ZnS, ZnSe, Al₂O₃, MgO, SeO₃, ZrO₂, and MoS₂.

10. The composition according to claim 9, wherein the titanium oxide is TiO₂.

11. The composition according to claim 9, wherein the iron oxide is Fe₂O₃.

12. The composition according to claim 6, wherein the substrates are chosen metals, metal derivatives, glasses, ceramics, aluminas, silicas, silicates, and synthetic mica.

13. The composition according to claim 12, wherein the silicate is chosen aluminosilicates and borosilicates.

14. The composition according to claim 12, wherein the synthetic mica is fluorophlogopite.

15. The composition according to claim 6, wherein the substrates comprise a two-layer structure.

16. The composition according to claim 6, wherein the substrates comprise a multilayer structure.

17. The composition according to claim 1, wherein the at least one particle with a metallic glint is flat.

18. The composition according to claim 1, wherein the at least one particle with a metallic glint is in the form chosen from platelets.

19. The composition according to claim 1, wherein the at least one particle with a metallic glint comprises a shape factor of greater than or equal to 8.

20. The composition according to claim 19, wherein the at least one particle with a metallic glint comprises a shape factor of greater than or equal to 10.

21. The composition according to claim 1, wherein the at least one particle with a metallic glint comprises, according to its greatest dimension, a mean size of less than or equal to 25 μm.

22. The composition according to claim 21, wherein the at least one particle with a metallic glint comprises, according to its greatest dimension, a mean size of less than or equal to 10 μm.

23. The composition according to claim 1, wherein the at least one texturizing agent is present in an amount greater than or equal to 2% by weight relative to the total weight of the composition.

24. The composition according to claim 23, wherein the at least one texturizing agent is present in an amount greater than or equal to 5% by weight relative to the total weight of the composition.

25. The composition according to claim 1, wherein the at least one texturizing agent is chosen from film-forming agents, resins, additional agents which are able to form a film, thickening agents and their mixtures.

26. The composition according to claim 25, wherein the film-forming agent comprises at least one film-forming polymer chosen radical polymers, polycondensates and polymers of natural origin.

27. The composition according to claim 26, wherein the at least one film-forming polymer is present in an amount greater than of equal to 0.1% by weight, relative to the total weight of the composition.

28. The composition according to claim 26, wherein the at least one film-forming polymer is present in an amount less than or equal to 7% by weight, relative to the total weight of the composition.

29. The composition according to claim 25, wherein the thickening agent is chosen from thickeners for a non-aqueous phase and thickeners for an aqueous phase.

30. The composition according to claim 29, wherein the thickener for a non-aqueous phase is chosen from hydrophobic silicas, optionally modified clays and polysaccharide alkyl ethers.

31. The composition according to claim 29, wherein the thickener for an aqueous phase is chosen from aqueous gelling polymers and clays.

32. The composition according to claim 25, wherein the thickening agents are present in an amount less than or equal to 5% by weight, relative to the total weight of the composition.

33. The composition according to claim 1, wherein the composition further comprises at least one medium chosen from at least one organic solvent medium and at least one aqueous medium.

34. The composition according to claim 1, wherein the composition further comprises at least one additional coloring material chosen from natural pearlescent agents, synthetic pearlescent agents, non-metallic pigments, non-metallic particles, natural fibers, synthetic fibers, water-soluble dyes and fat-soluble dyes.

35. A composition comprising, in a physiologically acceptable medium, at least one particle with a metallic glint, and at least one texturizing agent present in an amount less than or equal to 15% by weight, relative to the total weight of the composition, wherein the composition is capable of forming a film for which the wear resistance, expressed as loss in weight LW measured according to Standard AFNOR NF T30-015, is greater than 5% by weight.

36. The composition according to claim 35, wherein the wear resistance is greater than 10% by weight, relative to the total weight of the composition.

37. The composition according to claim 36, wherein the wear resistance is greater than 15% by weight, relative to the total weight of the composition.

38. The composition according to claim 35, wherein the at least one particle with a metallic glint is present in an amount greater than or equal to 2% by weight, relative to the total weight of the composition.

39. The composition according to claim 38, wherein the at least one particle with a metallic glint is present in an amount greater than or equal to 5% by weight, relative to the total weight of the composition.

40. The composition according to claim 39, wherein the at least one particle with a metallic glint is present in an amount greater than or equal to 7% by weight, relative to the total weight of the composition.

41. The composition according to claim 40, wherein the at least one particle with a metallic glint is present in an amount ranging from 2% to 20% by weight, relative to the total weight of the composition

42. The composition according to claim 35, wherein the at least one particle with a metallic glint is chosen from:
metals and metal derivatives and
substrates at least partially covered with at least one layer of a metallic glint chosen from metals and metal derivatives.

43. The composition according to claim 42, wherein the at least one metal is chosen from Ag, Au, Cu, Al, Zn, Ni, Mo, and Cr.

44. The composition according to claim 42, wherein the at least one metal derivative is chosen from titanium oxides, iron oxides, tin oxides, chromium oxides, MgF₂, TiCl₄, CrF₃, ZnS, ZnSe, Al₂O₃, MgO, SeO₃, ZrO₂, and MoS₂.

45. The composition according to claim 44, wherein the titanium oxide is TiO₂.

46. The composition according to claim 44, wherein the iron oxide is Fe₂O₃.

47. The composition according to claim 42, wherein the at least one substrate is chosen from metals, metal derivatives, glasses, ceramics, aluminas, silicas, silicates, and synthetic mica.

48. The composition according to claim 47, wherein the silicate is chosen from aluminosilicates and borosilicates.

49. The composition according to claim 47, wherein the synthetic mica is fluorophlogopite.

50. The composition according to claim 42, wherein the substrates have a two-layer structure.

51. The composition according to claim 42, wherein the substrates have a multilayer structure.

52. The composition according to claim 35, wherein the at least one particle with a metallic glint is flat.

53. The composition according to claim 35, wherein the at least one particle with a metallic glint is in the form chosen from platelets.

54. The composition according to claim 35, wherein the at least one particle with a metallic glint comprises a shape factor of greater than or equal to 8.

55. The composition according to claim 54, wherein the at least one particle with a metallic glint comprises a shape factor of greater than or equal to 10.

56. The composition according to claim 35, wherein the at least one particle with a metallic glint comprises, according to its greatest dimension, a mean size of less than or equal to 25 μm.

57. The composition according to claim 56, wherein the at least one particle with a metallic glint comprises, according to its greatest dimension, a mean size of less than or equal to 10 μm.

58. The composition according to claim 35, wherein the at least one texturizing agent is present in an amount less than or equal to 10% by weight, relative to the total weight of the composition.

59. The composition according to claim 58, wherein the at least one texturizing agent is present in an amount greater than or equal to 2% by weight, relative to the total weight of the composition.

60. The composition according to claim 59, wherein the at least one texturizing agent is present in an amount greater than or equal to 5% by weight, relative to the total weight of the composition.

61. The composition according to claim 35, wherein the at least one texturizing agent is chosen from film-forming agents, resins, additional agents which are able to form a film, thickening agents and their mixtures.

62. The composition according to claim 61, wherein the film-forming agent comprises at least one film-forming polymer chosen from radical polymers, polycondensates and polymers of natural origin.

63. The composition according to claim 62, wherein the at least one film-forming polymer is present in an amount ranging from 0.1% to 15% by weight, relative to the total weight of the composition.

64. The composition according to claim 61, wherein the at least one film-forming polymer is present in an amount less than or equal to 7% by weight, relative to the total weight of the composition.

65. The composition according to claim 61, wherein the thickening agent is chosen from thickeners for a non-aqueous phase, and thickeners for an aqueous phase.

66. The composition according to claim 65, wherein the thickener for a non-aqueous phase is chosen from hydrophobic silicas, optionally modified clays and polysaccharide alkyl ethers.

67. The composition according to claim 65, wherein the thickener for an aqueous phase is chosen from aqueous gelling polymers and clays.

68. The composition according to claim 61, wherein the thickening agents are present in an amount less than or equal to 5% by weight, relative to the total weight of the composition.

69. The composition according to claim 35, wherein the composition comprises at least one medium chosen from at least one organic solvent medium and at least one aqueous medium.

70. The composition according to claim 35, wherein the composition further comprises at least one additional coloring material chosen from natural pearlescent agents, synthetic pearlescent agents, non-metallic pigments, non-metallic particles, natural fibers, synthetic fibers, water-soluble dyes and fat-soluble dyes.

71. A composition comprising, in a physiologically acceptable medium, at least one particle with a metallic glint present in an amount greater than or equal to 2% by weight, relative to the total weight of the composition, and at least one texturizing agent present in an amount less than or equal to 15% by weight, relative to the total weight of the composition with the proviso that the composition does not contain silicon dioxide particles coated with a metal or a metal oxide.

72. A multi-compartment device or kit, wherein the first compartment comprises a first composition comprising, in a first physiologically acceptable medium, at least one particle with a metallic glint present in an amount greater than or equal to 2% by weight, relative to the total weight of the first composition and at least one texturizing agent present in an amount less than or equal to 15% by weight, relative to the total weight of the first composition, and wherein the second compartment comprises a second composition, different from the first composition, comprising, in a second physiologically acceptable medium, at least one film-forming agent present in an amount of at least 10% by weight, relative to the total weight of the second composition.

73. The kit according to claim 72, wherein the first composition comprises, in a physiologically acceptable medium, at least one particle with a metallic glint in an amount greater than or equal to 2% by weight, relative to the total weight of the composition, and at least one texturizing agent present in an amount less than or equal to 10% by weight, relative to the total weight of the composition.

74. The kit according to claim 72, wherein the second composition comprises at least one film-forming agent present in an amount of at least 15% by weight, relative to the total weight of the second composition.

75. The kit according to claim 72, wherein the second composition further comprises at least one thickening agent.

76. The kit according to claim 72, wherein the second physiologically acceptable medium comprises at least one medium chosen from at least one organic solvent medium and at least one aqueous medium.

77. The kit according to claim 72, wherein the second composition is chosen from translucent, semi-transparent and transparent.

78. The kit according to claim 72, wherein the second composition comprises at least one coloring material chosen from dyes which are soluble in the second physiologically acceptable medium and pulverulent compounds.

79. The kit according to claim 72, wherein the first composition comprises, in a physiologically acceptable medium, at least one particle with a metallic glint present in an amount greater than or equal to 2% by weight, relative to the total weight of the composition, and at least one texturizing agent present in an amount less than or equal to 15% by weight, relative to the total weight of the composition with the proviso that the composition does not contain silicon dioxide particles coated with a metal or a metal oxide.

80. A multi-compartment device or kit, wherein the first compartment comprises a first composition comprising, in a first physiologically acceptable medium, at least one particle with a metallic glint, wherein the first composition is capable of forming a film for which the wear resistance, expressed as loss in weight, measured according to Standard AFNOR NF T30-015, is greater than 5% by weight and wherein the second compartment comprises a second composition, different from the first composition, comprising, in a second physiologically acceptable medium, at least one film-forming agent present in an amount of at least 10% by weight, relative to the weight of the second composition.

81. The kit according to claim 80, wherein the first composition further comprises at least one texturizing agent present in an amount less than or equal to 15% by weight, relative to the total weight of the composition.

82. The kit according to claim 80, wherein the wear resistance is greater than 10% by weight.

83. The kit according to claim 80, wherein the second composition comprises at least one film-forming agent present in an amount of at least 15% by weight, relative to the total weight of the second composition.

84. The kit according to claim 80, wherein the second composition further comprises at least one thickening agent.

85. The kit according to claim 80, wherein the second physiologically acceptable medium comprises at least one medium chosen from at least one organic solvent medium and at least one aqueous medium.

86. The kit according to claim 80, wherein the second composition is translucent, semi-transparent or transparent.

87. The kit according to claim 80, wherein the second composition comprises at least one coloring material chosen from the group comprising dyes which are soluble in the second physiologically acceptable medium and pulverulent compounds.

88. A method for making up nails comprising applying to the nail to be made up at least one layer of a composition which comprises, in a physiologically acceptable medium, at least one particle with a metallic glint present in an amount greater than or equal to 2% by weight, relative to the total weight of the composition, and at least one texturizing agent present in an amount less than or equal to 10% by weight, relative to the total weight of the composition.

89. A method for making up nails comprising applying to the nail to be made up at least one layer of a composition which comprises, in a physiologically acceptable medium, at least one particle with a metallic glint and at least one texturizing agent present in an amount less than or equal to 15% by weight, relative to the total weight of the composition, and wherein the composition is capable of forming a film for which the wear resistance, expressed as loss in weight LW measured according to Standard AFNOR NF T30-015, is greater than 5% by weight.

90. A method for making up nails comprising applying to the nail to be made up at least one layer of a composition which comprises, in a physiologically acceptable medium, at least one particle with a metallic glint present in an amount greater than or equal to 2% by weight, relative to the total weight of the composition, and at least one texturizing agent present in an amount less than or equal to 15% by weight, relative to the total weight of the composition with the proviso that the composition does not contain silicon dioxide particles coated with a metal or a metal oxide.

91. A method for making up nails comprising applying to the surface to be made up, at least one layer of each of the compositions of a multi-compartment device or kit for making up the nails, wherein the first compartment comprises a first composition comprising, in a first physiologically acceptable medium, at least one particle with a metallic glint present in an amount greater than or equal to 2% by weight, relative to the total weight of the first composition and at least one texturizing agent or a mixture of texturizing agents present in an amount less than or equal to 15% by weight, relative to the total weight of the first composition, and wherein the second compartment comprises a second composition, different from the first composition, comprising, in a second physiologically acceptable medium, at least one film-forming agent present in an amount of at least 10% by weight, relative to the total weight of the second composition.

92. A method for making up nails comprising applying to the nail to be made up, at least one layer of each of the compositions of a multi-compartment device or kit for making up the nails, wherein the first compartment comprises a first composition comprising, in a first physiologically acceptable medium, at least one particle with a metallic glint present in an amount greater than or equal to 2% by weight, relative to the total weight of the first composition and at least one texturizing agent present in an amount less than or equal to 15% by weight, relative to the total weight of the first composition, and wherein the second compartment comprises a second composition, different from the first composition, comprising, in a second physiologically acceptable medium, at least one film-forming agent present in an amount of at least 10% by weight, relative to the total weight of the second composition.

93. A made-up synthetic support comprising at least one layer of a composition comprising, in a physiologically acceptable medium, at least one particle with a metallic glint present in an amount greater than or equal to 2% by weight, relative to the total weight of the composition, and at least one texturizing agent present in an amount less than or equal to 10% by weight, relative to the total weight of the composition.

94. A made-up synthetic support comprising at least one layer of a composition comprising, in a physiologically acceptable medium, at least one particle with a metallic glint and at least one texturizing agent present in an amount less than or equal to 15% by weight, relative to the total weight of the composition, and wherein the composition is capable of forming a film for which the wear resistance, expressed as loss in weight LW measured according to Standard AFNOR NF T30-015, is greater than 5% by weight.

95. A made-up synthetic support comprising at least one layer of a composition comprising, in a physiologically acceptable medium, at least one particle with a metallic glint present in an amount greater than or equal to 2% by weight, relative to the total weight of the composition, and at least one texturizing agent present in an amount less than or equal to 15% by weight, relative to the total weight of the composition with the proviso that the composition does not contain silicon dioxide particles coated with a metal or a metal oxide.

96. A made-up synthetic support comprising at least one layer of each of the compositions of a multi-compartment device or kit for making up the nails, wherein the first compartment comprises a first composition comprising, in a first physiologically acceptable medium, at least one particle with a metallic glint present in an amount greater than or equal to 2% by weight, relative to the total weight of the first composition and at least one texturizing agent present in an amount less than or equal to 15% by weight, relative to the total weight of the first composition, and wherein the second compartment comprises a second composition, different from the first composition, comprising, in a second physiologically acceptable medium, at least one film-forming agent present in an amount of at least 10% by weight, relative to the total weight of the second composition.

97. A made-up synthetic support comprising at least one layer of each of the compositions of a multi-compartment device or kit for making up the nails, wherein the first compartment comprises a first composition comprising, in a first physiologically acceptable medium, at least one particle with a metallic glint present in an amount greater than or equal to 2% by weight, relative to the total weight of the first composition and at least one texturizing agent present in an amount less than or equal to 15% by weight, relative to the total weight of the first composition, and wherein the second compartment comprises a second composition, different from the first composition, comprising, in a second physiologically acceptable medium, at least one film-forming agent present in an amount of at least 10% by weight, relative to the total weight of the second composition.
